(19) United States
(12) Patent Application Publication
(10) Pub. No.: US 2012/0114167 A1
(43) Pub. Date: May 10, 2012

(54) REPEAT CLIP IDENTIFICATION IN VIDEO DATA

(75) Inventors: Qi Tian, Singapore (SG); Xian F. Yang, Singapore (SG); Ping Xue, Singapore (SG)

(73) Assignees: NANYANG TECHNOLOGICAL UNIVERSITY, Singapore (SG); AGENCY FOR SCIENCE, TECHNOLOGY AND RESEARCH, Singapore (SG)

(21) Appl. No.: 12/092,616

(22) PCT Filed: Nov. 7, 2005
(86) PCT No.: PCT/SG2005/000379

§ 371 Date: Nov. 4, 2008

(51) Int. Cl. G06K 9/46; G06K 9/48; G06K 9/62

(52) U.S. Cl. 382/100; 382/224; 382/170; 382/165

(57) ABSTRACT

A method and System for identifying repeat clip instances in video data. The method comprises partitioning the video data into ordered video units utilising content-based keyframe sampling, wherein each video unit comprises a sequence interval between two consecutive keyframes; creating a fingerprint for each video unit; grouping at least two consecutive video units into one time-indexed video segment; and identifying the repeat clip instances based on correlation of the video segments. The method can be used for both discovering unknown repeat video clips and identifying instances of known repeat video clips automatically. The method can be used to identify short repeat video clips from less than a second long to a few minutes, such as tv station logos, program logos, tv commercials which are widely used in news video and other daily broadcasting programs.

### FIELD OF INVENTION

The present invention relates broadly to a method and system for identifying repeat clip instances in video data, and to a data storage medium having stored thereon computer code means for instructing a computer to execute a method of identifying repeat clip instances in video data.

### BACKGROUND

Digital video has become very popular, both at work and at home. Due to the rapid advances of computer, communication, and semiconductor technologies, video production, transmission, re-production, storage and sharing can be performed with ease and at low cost. However, it is now becoming critical how to search, retrieve and navigate large video collections for accessing the video content efficiently and effectively.

For example, most current TV commercial detection algorithms are based on detection of black frames before and after TV commercials, including the algorithm described in U.S. Pat. No. 6,100,941. However black frames before and after TV commercials are not universally practiced, for instance, in many countries in Asia there are no black frames used to separate TV commercials from regular video programs. Once TV commercials are detected, they can be either skipped or replaced with other video segments according to pre-defined rules.

Furthermore, audio analysis has been used for detection of TV commercials based on types of audio such as silence, music, noise and speech in published United States Patent Application No. 20040201784.

TV commercials real-time monitoring systems such as described in U.S. Pat. No. 5,504,518 store signatures, video and audio features, of a predefined set of TV commercials to be monitored. Then these signatures are compared with a broadcasting video to identify instances of the TV commercials stored in the database.

Learning based TV commercial detection is described in published United States Patent Application No. 20040161154. Visual, audio and context based features are used to train classifiers to classify commercials against non-commercials with supporting vector machines (SVM) or other pattern classifiers.

The above detection or classification techniques are based on identifying the relevant portions of the digital video through a comparison with “artificial” reference data, and the identification proceeds via identifying those portions of the video that match the reference data that represents what is being “looked for”.

However, beside TV commercials there are other types of short video clips used in video content production, including news video, sports video, documentary video, etc. where the short video clips are used as syntactic structural elements (SSEs) to indicate a structure of a video program. For instance, a daily news program, say, 30 min. long, usually consists of international news, local news, financial news, sports news, weather segments, etc. For each segment a short video lead-in or lead-out is used to indicate the starting and ending points of the segment. Identifying SSEs and then detecting instances of the SSEs in a video content collection can be useful, e.g. for video content retrieval. The above-mentioned detection or classification techniques are of limited use in identifying SSEs, since they require the artificial reference data to be available for the respective SSEs, which is impractical given the large variety of different SSEs that may be present in video data.

To address this problem, recently identifying SSEs has been approached based on techniques for identifying repeated video sequences in video data. In other words, the SSEs are identified based on identifying actual repeated video sequences in the video data, rather than identifying those video sequences which have a predetermined characteristic such as identifying black frames.

Pua et al. (KM Pua, et al., Real time repeated video sequence identification, Computer vision and Image Understanding, 93, (2004), pp. 310-327) presented a real-time repeated video shot identification method to detect repeated video shots based on a color moment feature of key frames. The method can be used to deduce semantic relationships of video, detect TV commercials, etc. The limitations of this method include that it utilises video shots as the “fundamental” unit of the identification. As a result, this method inherently cannot identify repeated video sequences at a sub-shot level and relies on the identification of video shots, which is becoming more difficult as video shots are linked together by transitional video data, thus making the transition between shots more seamless and difficult to detect.

Therefore, a need exists to develop an automatic and efficient short video clip identification technique that addresses one or more of the above mentioned problems.

### SUMMARY

In accordance with a first aspect of the present invention there is provided a method of identifying repeat clip instances in video data, the method comprising partitioning the video data into ordered video units utilising content-based keyframe sampling, wherein each video unit includes a sequence interval between two consecutive keyframes; grouping at least two consecutive video units into one time-indexed video segment; and identifying the repeat clip instances based on correlation of the video segments.

A fingerprint may be created for each video unit, the fingerprint comprising a content-based feature vector.

The content-based feature vector may be based on one or more of a group consisting of a color content, an image histogram, a segment length and motion activities of the video unit.

A correlation matrix of video segments from one input video alone may be derived based on an auto-correlation of the fingerprints and on temporal features of the time-indexed video segments, and the repeat clip instances are identified from the correlation matrix.

A correlation matrix of video segments from two different input videos may be derived based on cross-correlation of the fingerprints and on temporal features of the time-indexed video segments, and the repeat clip instances are identified from the correlation matrix.

A similarity between video segments may be defined as a binary value, with one pair of identical video segments correspond to element “1” in the correlation matrix, and the repeat clips are identified from the observation of those identical video segments.

Only the time indices of elements “1” may be recorded in an array while the entire correlation matrix is not recorded.

The method may further comprise connecting line segments in the correlation matrix, each line segment comprising diagonally adjacent matrix elements of the same value “1”, for identifying the repeat clip instances.

The line segments connecting may proceed in a hierarchical way, wherein most reliable line segments with a length≧2 are first connected, followed by connecting less reliable line segments with a length=1 to expand a line segment boundary.

The connecting of the line segments may be based on a temporal relation of the associated video sequences.

The method may further comprise performing a locality-sensitive hashing to identify fingerprints that are within a pre-determined distance from each other, and calculating elements of the correlation matrix only for said identified fingerprints.

The fingerprints may be transformed into a bit string, and the hashing is applied to the bit strings corresponding to the respective fingerprints.

The method may further comprise conducting a frame-by-frame frame feature comparison of the identified repeat clip instances to verify said repeat clip instances if a comparison measure is above a pre-determined threshold.

The method may further comprise conducting a frame-by-frame boundary expansion for verified repeat clip instances.

The method may further comprise labeling repeat clip instances as belonging to same or different groups of matched repeat clip instances based on a temporal relationship between the associated video sequences.

The key frames may be identified based on a content histogram of each frame of the video stream.

The content histogram may comprise a color histogram or a motion histogram.

The video data may comprise one or two video streams.

The video data may comprise one or two stored video collection data.

The video data may comprise one stored video collection data and one video stream.

The method may be performed in on-line in real time.

The method may be performed off-line.

In accordance with a second aspect of the present invention there is provided a system for identifying repeat clip instances in video data, the system comprising a partitioning unit for partitioning the video data into ordered video units utilising content-based keyframe sampling, wherein each video unit includes a sequence interval between two consecutive keyframes; a processor for grouping at least two consecutive video units into one time-indexed video segment and for identifying the repeat clip instances based on correlation of the video segments.

In accordance with a third aspect of the present invention there is provided a data storage medium having stored thereon computer code means for instructing a computer to execute a method of identifying repeat clip instances in video data, the method comprising partitioning the video data into ordered video units utilising content-based keyframe sampling, wherein each video unit includes a sequence interval between two consecutive keyframes; grouping at least two consecutive video units into one time-indexed video segment; and identifying the repeat clip instances based on correlation of the video segments.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1a shows a schematic drawing illustrating key-frame based video sampling and partitioning according to an example embodiment.

FIG. 1b shows a schematic drawing illustrating a three level video representation according to an example embodiment, namely Video unit (VU), Video segment (VS), and Video clip (VC)

FIG. 2 shows an implementation of a hashing algorithm according to an example embodiment.

FIG. 3 shows an extract of a similarity matrix used in repeated video clip identification according to an example embodiment.

FIG. 4 is a schematic drawing illustrating connecting of adjacent line segments in repeated video clip identification according to an example embodiment.

FIG. 5 is a schematic drawing illustrating labeling of instances used in repeated video clip identification according to an example embodiment.

FIG. 6 shows a system charged of an off line repeated video clip mining system according to an example embodiment.

FIG. 7 shows a schematic drawing of a computer system for implementing a repeated video clip mining method and system according to an example embodiment.

FIG. 8 is a flowchart illustrating a method of repeat clip identification in video data according to an example embodiment.

### DETAILED DESCRIPTION

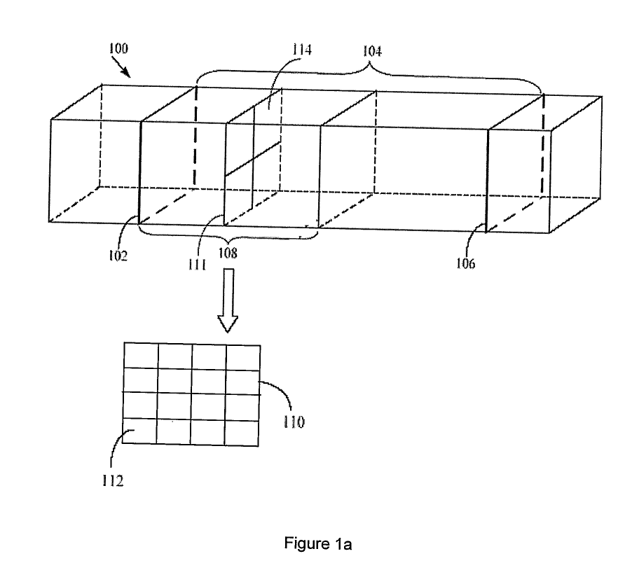

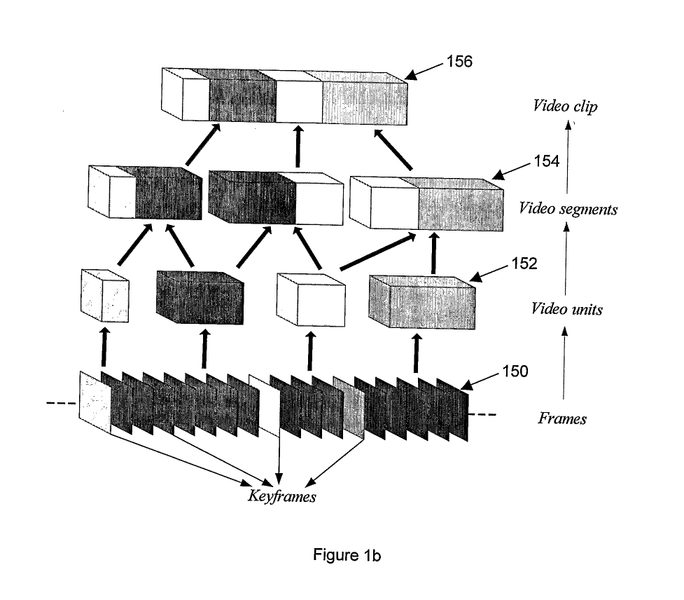

The example embodiment adopts a key-frame based video sampling and partitioning strategy which is dependent on the video data characteristic, i.e. content-based. As shown in FIG. 1a, video data 100 is sampled by key-frames e.g. 102, and intervals 104 between two consecutive key-frames 102, 106 are each treated as one video unit, which in turn is time indexed by its first (key-) frame.

Key-frame selection criteria in the example embodiment are based on the color histogram difference between a current frame and the last keyframe. If Hᵢ and Hₒ are color histograms of the current ith frame and the last key-frame respectively, then if

|1−inter(Hᵢ,H₀)|>η, (1)

ith frame->key-frame, and Hₒ=Hᵢ

Where (Hᵢ, Hₒ) is the intersection of the two histograms, and η is the threshold.

The advantage of the key-frame based video sampling strategy in the example embodiment include that such a sampling is robust to shifting of starting frames. Even if two repeated video clips begin at different frames, the selected key-frame sequences of the clips can be synchronized after certain frames. The synchronization speed is related to content characteristic, but generally synchronization can be obtained after a shot cut. On the contrary, a uniform sampling method lacks a mechanism to correct shifting errors.

A further advantage is that key-frame based sampling can reduce correlation between adjacent samples, so high cross-similarity values between adjacent samples can be suppressed, which can make diagonal patterns in an auto-correlation matrix sharper and easier to be identified. Another advantage of this non-uniform partitioning strategy is that a temporal feature of the video segment can be incorporated in the video feature representation. The combination of a temporal feature and a content feature can increase feature discriminative ability, and result in low false positive errors. On the other hand, for uniform sampling, the temporal feature is not utilised. The example embodiment, in applying non-uniform sampling and partitioning, can achieve higher precision than a uniform partition strategy.

Two types of video features are extracted from a video stream in the example embodiment. The first feature is a video unit feature, the second feature is a frame feature.

The representation of video units is a combination of a color feature and a temporal feature. The color feature adopted in the example embodiment is a color fingerprint proposed by Yang et. al. (Xianfeng Yang, Qi Tian, E. G. Chang. A Color Fingerprint of Video Shot for Content Identification. Proc. ACM Multimedia 2004, NY, USA, 2004), and the temporal feature is unit length. The color fingerprint is compact and robust to noise and image quality reduction, even brightness and contrast changes. Moreover, a good balance between robustness and discrimination can be chosen, to achieve low identification errors.

A video unit 104 is partitioned into K sub-segments 108, and represented by K blending images 110 formed by averaging frames 111 within each sub-segment 108 along the time direction. Each blending image 110 is then divided into M×N equal size blocks 112. For each block 112, the major and minor color components among R,G,B are selected as the representative feature of that block. The color fingerprint of this segment is an ordered concatenation of these block features, and the fingerprint dimension is 2×K×M×N. If R̅, G̅, B̅ are the average color values of a block 112, with a descending order of values V1, V2, V3, then the major color and minor color are determined by the following rules:

$$\begin{matrix}Rule 1 \text{:} & If ( {V}_{1} - {V}_{3} ) > δ \\ & Major Color = \{ \begin{matrix}argmax ( \overline{R} , \overline{G} , \overline{B} ) & if ( {V}_{1} - {V}_{2} ) > τ \\ uncertain & if ( {V}_{1} - {V}_{2} ) \leq τ\end{matrix} \\ & Minor Color = \{ \begin{matrix}argmin ( \overline{R} , \overline{G} , \overline{B} ) & if ( {V}_{2} - {V}_{3} ) > τ \\ uncertain & if ( {V}_{2} - {V}_{3} ) \leq τ\end{matrix}\end{matrix}$$

Where δ is the threshold value that differentiates color image and gray value image, and is often set to a very small value, and τ is the parameter that can control the robustness and discrimination of the feature.

$$\begin{matrix}Rule 2 \text{:} & If ( {V}_{1} - {V}_{3} ) \leq δ \\ & Major Color = Minor Color = \{ \begin{matrix}bright & if {V}_{1} > {V}_{2} \\ dark & if {V}_{1} \leq {V}_{2}\end{matrix}\end{matrix}$$

Major and minor color patterns have six possible symbol values, {R, G, B, U, L, H}, where U, L, H stand for uncertain, dark, bright respectively. The robustness and discriminative power of this color fingerprint can be controlled by the parameters δ and τ.

In the example embodiment one blending image (K=1) is used for each segment, and the blending image is divided into 8×8 blocks (M=N=8). The parameter τ that mainly controls robustness and discriminative ability is set to 3, while δ is set as 0.001.

Also extracted is a feature of each frame 111 for the purpose of frame by frame verification of repeated clips. Each frame 111 is divided into 4 sub-frames 114, and the color histogram of each sub-frame 114 is quantized to a symbol, so each frame 111 is represented by 4 symbols.

Each symbol being one byte, for a 24 hrs video that is digitized at 30 fps, the storage requirement for the symbol string feature is 10,368,000 (9.9M) bytes. In the example embodiment, a code book size of 128 was used, noting that a small code book size provides more robustness, while providing less discrimination.

In the example embodiment, in similarity measurement of video units, two consecutive video units {vᵢ, vⱼ₊₁} are grouped together to match against other consecutive units {vⱼ, vⱼ₊₁}. A similarity value s(i,j) is computed by matching {v₁, vᵢ₊₁} against {vⱼ, vⱼ₊₁}. The window will be sliding through each unit and create the similarity matrix.

The single video unit similarity between vₗ and vⱼ is measured by both color fingerprint and unit length,

$$Sim ( {v}_{i} , {v}_{j} ) = \{ \begin{matrix}1 & if d ( {F}_{i} , {F}_{j} ) < {ɛ}_{1} \& \frac{\vert Len ( {v}_{i} ) - Len ( {v}_{j} ) \vert}{min ( Len ( {v}_{i} ) , Len ( {v}_{j} ) )} < {ɛ}_{2} \\ 0 & otherwise\end{matrix} \qquad ( 2 )$$

where Fᵢ, Fⱼ, are color fingerprints of and vᵢ and vⱼ, Len(vᵢ), Len(vⱼ) are the lengths of vᵢ and vⱼ and ε₁, ε₂ are distance thresholds.

The value s(i,j) calculated as

$$s ( i , j ) = \{ \begin{matrix}1 & if Sim ( {v}_{i} , {v}_{j} ) = 1 \& Sim ( {v}_{i + 1} , {v}_{j + 1} ) = 1 \\ 0 & otherwise\end{matrix} \qquad ( 3 )$$

In the example embodiment binary similarity values are chosen. The advantage is that locating diagonals is easy in a binary matrix, and only the time indexes of element “1” are recorded, so that even very large video data can be analyzed with limited memory requirement. This similarity measure requires that both of two neighbour units are similar to other two neighbour units, for the similarity measure to be “1”.

FIG. 1b is a schematic representation of the hierarchy of three level video representation used in the example embodiment. More particular, from the data representation or frames level 150, the first level of video representation are the video units 152. The second level of the video representation comprises the video segments 154, each consisting of two consecutive video units 152, with overlap between the video segments 154. More than two consecutive video units 152 may be combined into one video segment 154 in different embodiments. The third level of video representation comprises a video clip 156, which may be aggregated from different video segments 154 as illustrated in FIG. 1b.

In using pair-wise comparison (see video segments 154) in the example embodiment to fill a N×N similarity matrix, there will be N² feature comparisons. Because of the symmetry property of the matrix, only half of the elements need to be computed, so the number of comparisons can be reduced to N(N+1)12. In most cases, the similarity matrix is a sparse one, since only a small portion of points within a certain distance have the possibility to produce the similarity value “1”, while most other comparisons will result in “0” values. If the searching range for a sample can be limited to those within a certain distance, most non-effective comparisons will be avoided, thus the complexity of the similarity matrix calculation will be further reduced. This may be achieved by employing locality-sensitive hashing (LSH) on the color fingerprints.

LSH can perform a (rE)-NN similarity search in sub-linear time. For a query point q in d-dimensional space, LSH can return indexed points within a certain distance with high probability, while those points beyond this distance have a low probability of being returned by the LSH. This is realized by designing a set of hash functions that can make the probability of a hash collision for two points be related to their similarity or distance. If two points are similar, their hash collision probability should be high; otherwise low. By using multiple such hash functions with different parameters in parallel, LSH can reduce the false negative rates, but also the false positive rate will increase at mean time. In the example embodiment, the hashing parameters are tuned to get a desired accuracy.

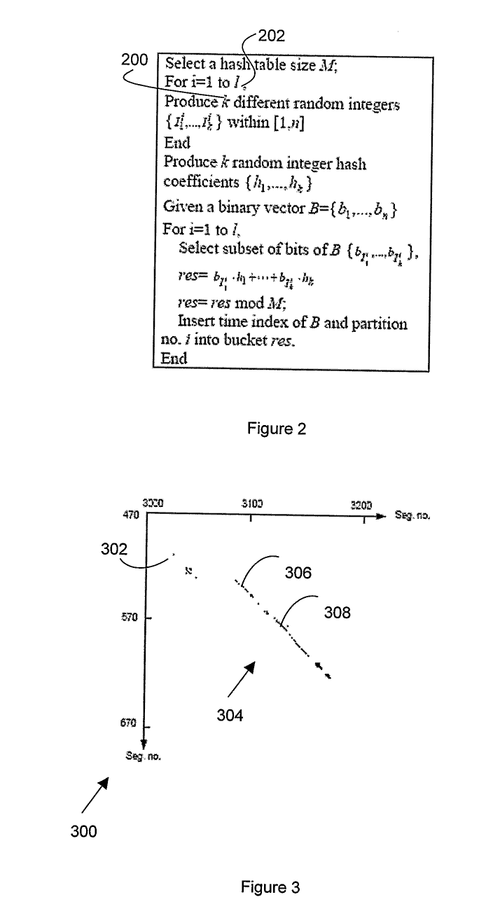

The LSH algorithm proposed by Gionis et al (A. Gionis, P. Indyky, R. Motwaniz. Similarity Search in High Dimensions via Hashing. In Proc. Int. Conf. on Very Large Data Bases, pages 518-529, 1999) is used in the example embodiment to speed up the computation in repeat short video clip mining. This transforms a feature vector into a bit string. The hash function is selecting a subset of bits of the bit string that satisfy the desired locality-sensitive properties. A set of/such hash functions is built, and each of them selects k bits from the bit string. These k bits are hashed to the index of buckets in a hash table. Implementation of the hashing algorithm in the example embodiment is shown in FIG. 2. The two parameters, k(200) and l(202) enable the designer to select an appropriate trade-off between accuracy and running time.

The color fingerprint can be directly indexed by the above LSH algorithm. Each of the six symbols that form the color fingerprint can be represented by three bits i.e. {R,G,B,U,L,H} are represented by {001, 010, 011, 100, 101, 110} respectively. In other words, a n dimensional color fingerprint is converted into a 3n length bit string. According to this hash function, the probability that an indexed point having r bit errors with a query point will be returned is estimated as:

1[1−(1−r)^{k}]^{l} (4)

From the color fingerprint distance threshold ε₁ in Eqs(2), one can estimate the bit error rate r, and then select appropriate k,l that can return points having r bit errors or less with high probability. Using the LSH algorithm described above, samples having a color fingerprint “close” to the color fingerprint of a query sample can thus be returned, and computation of the similarity is limited to the returned samples for the query sample, thus further reducing the complexity of the similarity matrix calculation in the example embodiment.

If visualised in matrix form, repeated video sequences will appear as diagonal lines of “1”, offset from the main diagonal, in the similarity matrix. However, due to keyframe extraction errors, the line may be split into non-connective line portions. Due to the use of non-uniform partitioning, these non-connective line portions may not be collinear. Since identification errors are not avoidable, the similarity between different video segments may be wrongly calculated as “1”, so some diagonal lines may not be single pixel width, and some diagonal lines are not real repeated video sequences. FIG. 3 is excerpted from a 4699×4699 matrix representation 300, illustrating the typical pattern for a pair of repeated sequences obtained by the example embodiment, where the dots or pixels e.g. 302 indicate “1” similarity values.

As is shown in FIG. 3, the whole repeated video sequence 304 is split into several non-collinear black lines portions e.g. 306, 308, which are not single pixel width. On the other hand, if one treats each line portion e.g. 306 as an isolated repeated video sequence, one may not get the whole image of the repeated video sequence, and identification errors may not be distinguished. An algorithm to hierarchically connect non-connective line portions to a whole one is designed in the example embodiment to absorb identification errors at mean time. Rather than using a line chain tracking algorithm and morphological filter to connect line segments and eliminate noise from the image, the lines are transformed to the temporal domain and operated on based on their temporal relationship. Accordingly, in the example embodiment, the algorithm does not create or calculate a similarity matrix in implementation. Rather, only the time indices of elements “1” are recorded in an array while the entire correlation matrix is not recorded, to avoid matrix explosion for large video data.

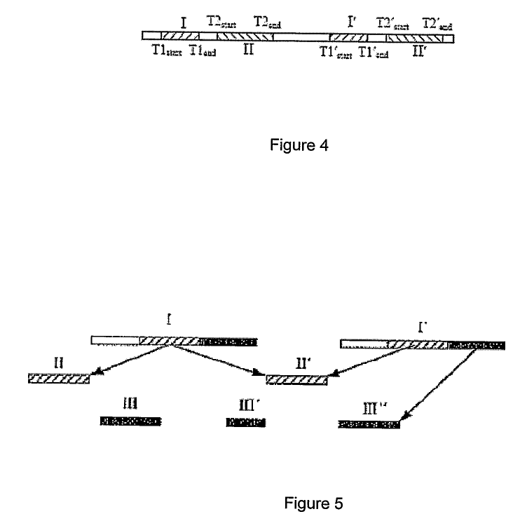

Step 1: Connecting adjacent line segments whose length exceeds one.
In the temporal domain, this corresponds to connecting repeated groups of two or more consecutive pairs of repeated video portions each. Compute the start and end time of the corresponding repeated video segments for each group. Let the start and end time of two repeated groups, (I,I′) and (II,II′), be (T1ₛₜₐᵣₜ,T1_{end}), (T1′ₛₜₐᵣₜ, T1′_{end}) and (T2ₛₜₐᵣₜ′, T2_{end}), (T2′ₛₜₐᵣₜ,T2′_{end}) respectively, as shown in FIG. 4 in the temporal domain. If one of the following conditions is satisfied, the repeated sequence segments will be merged or connected as one:

1>Overlap. T1ₛₜₐᵣₜ≦T2ₛₜₐᵣₜ≦T1_{end} and T1′ₛₜₐᵣₜ≦T2′ₛₜₐᵣₜ≦T1′_{end};

2>neighboring. T2ₛₜₐᵣₜ>T1_{end}, T2′ₛₜₐᵣₜ>T1′_{end} and |T2ₛₜₐᵣₜ−T1_{end}|<μ₁, |T2′ₛₜₐᵣₜ−T1_{end}|<μ₁ and |T2ₛₜₐᵣₜ−T1_{end})−(T2′ₛₜₐᵣₜ−T1′_{end})|<μ₂,

where μ₁, μ₂ are thresholds. The underlying assumption of condition 2 is that if two groups of two consecutive pairs of repeated video portions are close to each other, and the length of the gaps between corresponding occurrences of the groups are about the same, that gap is most likely caused by segmentation or feature errors rather than dissimilar segments. In the example embodiment, μ₁=10 s, μ₂=0.5 s.

The boundary of the connected repeated video portion is

Tₛₜₐᵣₜ=min(T1ₛₜₐᵣₜ,T2ₛₜₐᵣₜ), T_{end}=max(T1_{end},T2_{end}), and T′ₛₜₐᵣₜ=min(T1′ₛₜₐᵣₜ, T2′ₛₜₐᵣₜ), T′_{end}=max(T1′_{end},T2′_{end}).

The connected or merged video portions are put into a new list together with the corresponding start and end times, and the above merging or connecting processes (conditions 1 and 2 above) are repeated until there is no change between the input and output lists.

Step 2: Connecting single dots, in order to extend a boundary. The connection algorithm is same as in step 1, but searching for all pairs of repeated video portions. In step 1, there must be two or more consecutive pairs of repeated video portions, which means that at least two consecutive video segments are identical, which in turn means that three consecutive video units are identical.

This condition can reduce false positive errors, but may be too stringent for video segments near boundaries. Because selected keyframes of two repeated video sequences near their respective start boundary may not be well synchronized, it may be difficult to find three consecutive identical video units at start boundaries. Step 2 thus relaxes the condition to add more fragments of the repeated video sequence.

After step 2, the algorithm returns or loops back to step 1, since after step 2 different groups of consecutive pairs of repeated video portions may be close enough to be joint. Similarly, step 2 is then again applied after step 1, and the loop is repeated until there is no change in the output list.

Since the video data is non-uniformly partitioned, the final repeated video sequences pairs obtained through steps 1 to 3 above may have different lengths in the time domain due to error accumulation. If the length difference of the two detected repeated video sequences of a pair is greater than a threshold value, the repeated video sequences will be treated as errors. If the length of the repeated video sequence is lower than a threshold value, the sequences will also be discarded as errors. Suppose L1 and L2 are lengths of two repeated video sequences respectively, they are filtered, in the example embodiment, if

$$\vert {L}_{1} - {L}_{2} \vert > {μ}_{3} , or , \frac{\vert {L}_{1} - {L}_{2} \vert}{min ( {L}_{1} , {L}_{2} )} > {μ}_{4} , or , {L}_{1} or {L}_{2} < {μ}_{5} \qquad ( 5 )$$

where μ₃, μ₄ are thresholds.

After identifying repeated video sequence pairs as described above, it is further verified if the video sequence pairs are real repeated video clips in order to improve precision. Also, where only partial repeated clips are identified, it may be advantageous to further extend the boundaries of the video sequences based on the detected partial clips. The technique for further verification and boundary refinement in the example embodiment is a frame by frame comparison. The frame representation is 4 symbols, as described above.

To verify two repeated video sequences, the number of identical symbols are counted from the start frame to the end frame. If the percentage of identical symbols is above a threshold, for example 50%, the two repeated sequences pass verification as repeated video clips.

After two repeated sequences are so verified, the clip boundaries may be refined. Firstly, if the representation of the previous or following frames of the start or end frames respectively of both repeated sequences are identical, then the boundary is expanded by 1 frame. This process continues until a non-identical frame is encountered.

Furthermore, in repeated clip pairs, one instance of a pair can be paired with another instance of a pair. If a clip has n instances in the stream, based on combinatorial mathematics there should be Cₙ² repeated pairs. However, some instances may not be matched and some may be partially matched because some instances just appear as a partial clip, or due to an identification error. In a repeated instance extraction and labelling step, unique instances from such repeated clip pairs are identified and multiple boundaries of each instance are merged into one boundary.

After identifying unique instances, matched instances are grouped together and are given the same label. The labelling method in the example embodiment is based on the transitivity between repeated pairs. If clip A is pairing with clip B, and clip B is pairing with clip C, then clip A, B, C will be grouped together. Allowing partial match, if clip B′ paired with clip A is just a small partial instance of clip B paired with clip C, clips A, B′, B, C can be grouped together. However, this rule can encounter confusion when a repeated clip contains sub-repeated structures. As shown in FIG. 5, repeated clips I, I′ contain two independent sub-repeated clips II and III. II and III don't have sub-repeated structures, their repeated instances are II′ and III′, III″. I and I′ will be partially matched with II and III, but I, II, III should be given different labels, not the same one as would be the case following the method described above.

To try and avoid this incorrect labelling, the instance extraction and labelling algorithm in the example embodiment is as follows.

Step 1: Label repeated pairs of clips whose length is less than 7 seconds. Given a candidate repeated pair of clips, A and B, compute overlapping between stored instances of repeated clips, and clips A and B respectively. Overlapping between two clips X, Y is computed by:

$$overlap = \frac{min ( right ( X ) , right ( Y ) ) - max ( left ( X ) , left ( Y ) )}{max ( len ( X ) , len ( Y ) )} \qquad ( 6 )$$

where left(.), right(.) means left and right boundary, len(.) means length of the sequence.

If overlapping is greater than 0.3, the two clips are grouped together with the same label. The new boundary of the instance will be expanded to the minimum left boundary and maximum right boundary of the two candidate repeated pair of clips.

If only A finds its matched instance, B will also join the group, or vice versa. If both A and B find their matches, but their numbers of matched instances are not the same, then the instances in the group with larger number of instances will be merged into the group with smaller number of instances.

Step 2: The above process is applied to candidate repeated pairs of clips whose length is equal to or longer than 7 seconds. The difference is that the overlapping threshold is set to 0.6.

In this algorithm, a lower overlapping threshold is thus set for short clips, because partial overlapping is assume to be mainly caused by partial instance rather than a sub-repeated structure. However, for long clips, the overlapping threshold is higher to ensure identifying partial instances.

Prior knowledge about certain video programs may additionally be used to assist in the labelling and boundary refinement.

It will be appreciated by a person skilled in the art, that the example embodiment described above can provide an improved system and method for repeat clip identification in video data compared to existing methods and systems. More particular, the example embodiment can provide a finer granularity in the repeat clip identification, for example, the example embodiment can provide identification at a sub-shot level. Assuming e.g. sampling at more than one keyframes per second, a granularity below one second may be achieved. Thus, the present invention can enable shorter repeat clip identification in video data such as TV station logos and program logos which typically last only a few seconds. These short repeat video clips do not have a video shot structure, and thus existing video shot based repeat video identification methods are not able to identify all such shorter repeat clips.

On the other hand, because of the different layers of feature identification and aggregation, as described above, the example embodiment has a flexibility in the clip structure to be identified. In other words, the example embodiment also provides a coarse granularity which enables identification of long repeat clips in video data.

Furthermore, the example embodiment, in providing a boundary refinement layer, may provide an accurate identification of the actual boundaries of the repeat clips. In existing repeat clip identification methods and systems, often only an approximate location of the instances of the repeat clip can be identified, rather than the actual boundaries of the instances.

The example embodiment can identify repeated clips independent on existence of a shot structure. The example embodiment can also tolerate sequence length variations and group long and short sequences together, which can be more effective in video redundancy detection and syntactic segmentation. By labelling the whole repeated clip rather than isolated shots, the video stream can be segmented into more meaningful syntactic units thus providing good material for high level video data analysis.

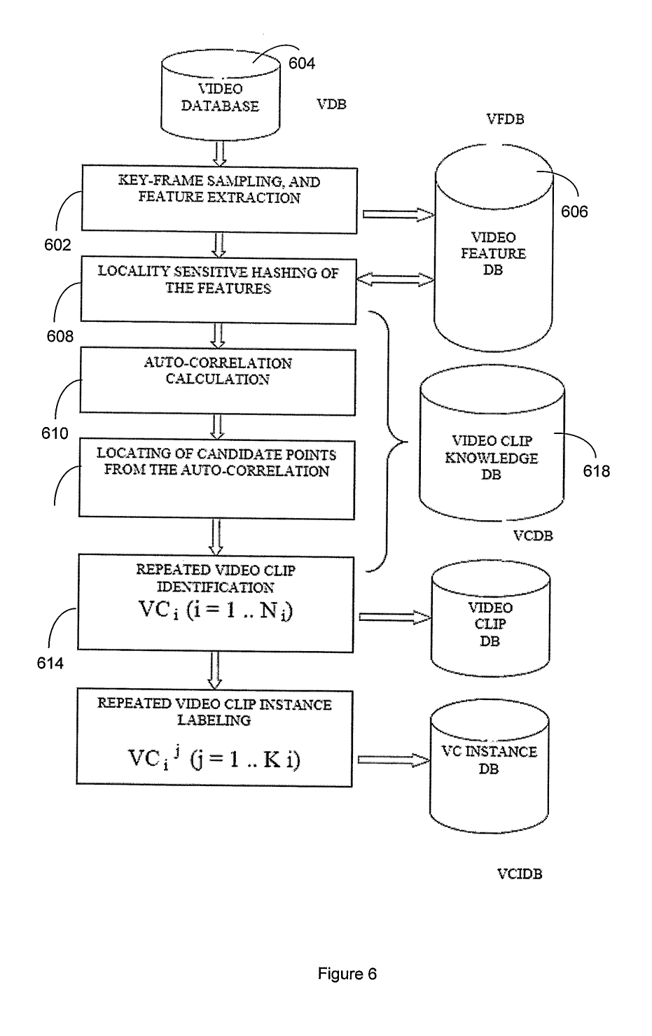

FIG. 6 is a schematic drawing of a system chart 600 for off line short repeat video clip identification according to an example embodiment. An extraction module 602 performs key-frame sampling and feature extraction on a video stored in a video database 604. The extracted features are stored in a video feature database 606.

A hashing module 608 performs a locality sensitive hashing of the features. The hashing module 608 is coupled to the feature extraction module 602. An auto-coloration calculation module 610 than performs auto-coloration calculation on the features remaining after the locality sensitivity hashing has been applied by the hashing module 608. From the auto-coloration calculation, a locating module 612 locates candidate points, which in turn are fed to a repeated video clip identification 614.

The identified repeated video clips are stored in a video clip database 614. It is noted that each of the hashing module 608, auto coloration calculation module 610, locating module 612 and repeated video clip identification module 614 are coupled to a video clip knowledge database 618, for reducing identification errors in the example embodiments. The video clip knowledge database 618 includes knowledge of short video clip categories and their corresponding characteristics, station logos, program logos of known TV stations. The knowledge database 618 can be built based on the results of repeat video clip identification on given video content collection, and it will be appreciated by a person skilled in the art how the knowledge database 618 can be build based on the results obtained from the example embodiment. The information in the knowledge database 618 can be used for discovering repeat video clips from a given new video content as well as to choose parameters used in feature detection 602, auto-correlation calculation 610 and repeated video clip identification 614.

The repeated video clips identified by the identification module 614 are then labelled and instance boundaries refined in the repeated video clip instance labelling module 620, and the results of the labelling are stored in a video clip instance database 622.

The system chart 600 in FIG. 6 is arranged for a stand-alone mode of operation. In the stand-alone mode of operation, only one video data input (from the video database 604) is received, and the repeat clip identification is based on an auto-correlation calculation (see module 610). This mode is e.g. initially used with a given video content collection in order to identify all repeat video clips in the collection. Subsequently, example embodiments can also be operated in an update mode, in which one video streaming input can be analyzed against the stored video content in the video database created early, and a cross-correlation calculation is performed to identify repeat clips between the two video data. In that way, instances of known repeat video clips in the streaming video input can be identified, as well as discovering unknown repeat video clips in the streaming video input.

Furthermore, embodiments of the present invention can be utilised to populate or generate repeat video clip libraries, which can serve as a reference library in repeat video clip identification. For this purpose, the example embodiment may be operated in a mode in which every identified repeat video clip and its relevant data are stored in the library, for example during an initial system boost to create the library. The example embodiment may also be operated in a mode in which identified repeat video clip and associated data are only stored in the library, they are different from previously stored data in the library. This mode of operation may be employed for updating or maintaining the library.

Many components in the example embodiment are open for choice, such as the keyframe extraction method, video feature representation, hashing function etc. The adopted keyframe extraction method and video features in the example embodiment can obtain good identification results on program logos, commercials. LSH of color fingerprint helps reduce correlation complexity up to 100 times, which makes this correlation based identification approach scalable to large video collections. The sequence linking and merging algorithm can efficiently correct keyframe extraction errors and feature comparison errors. The described verification stage can greatly improve precision without sacrificing recall.

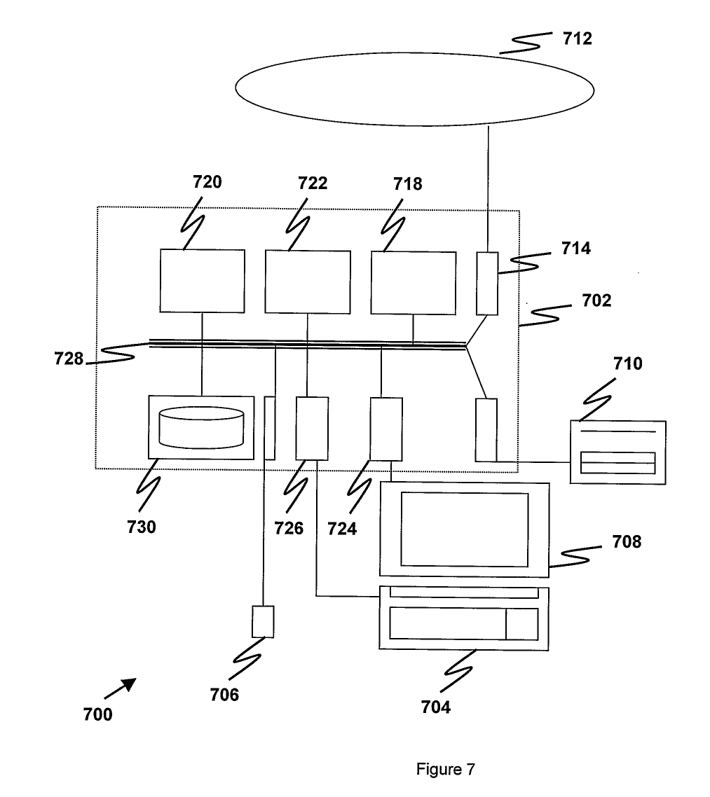

The method and system of the example embodiment can be implemented on a computer system 700, schematically shown in FIG. 7. It may be implemented as software, such as a computer program being executed within the computer system 700, and instructing the computer system 700 to conduct the method of the example embodiment.

The computer system 700 comprises a computer module 702, input modules such as a keyboard 704 and mouse 706 and a plurality of output devices such as a display 708, and printer 710.

The computer module 702 is connected to a computer network 712 via a suitable transceiver device 714, to enable access to e.g. the Internet or other network systems such as Local Area Network (LAN) or Wide Area Network (WAN).

The computer module 702 in the example includes a processor 718, a Random Access Memory (RAM) 720 and a Read Only Memory (ROM) 722. The computer module 702 also includes a number of Input/Output (I/O) interfaces, for example I/O interface 724 to the display 708, and I/O interface 726 to the keyboard 704.

The components of the computer module 702 typically communicate via an interconnected bus 728 and in a manner known to the person skilled in the relevant art.

The application program is typically supplied to the user of the computer system 700 encoded on a data storage medium such as a CD-ROM or flash memory devices and read utilising a corresponding data storage medium drive of a data storage device 730. The application program is read and controlled in its execution by the processor 718. Intermediate storage of program data maybe accomplished using RAM 720.

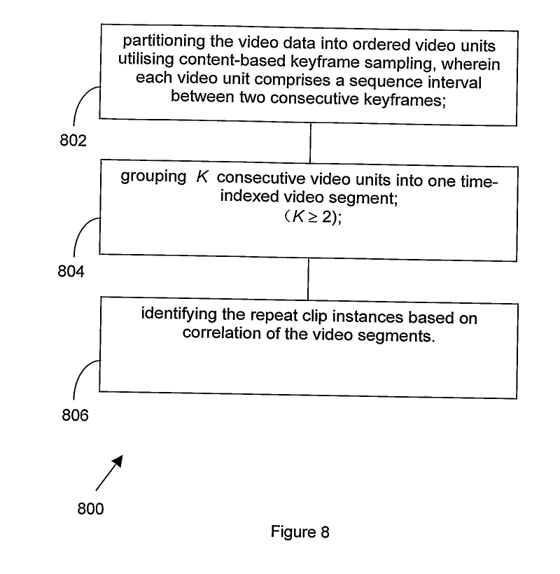

FIG. 8 shows a flowchart 800 illustrating a method of repeat clip identification in video data according to an example embodiment. At step 802, the video data is partitioned into ordered video units utilising content-based keyframe sampling, wherein each video unit comprises a sequence interval between two consecutive keyframes. At step 804, K consecutive video units are grouped into one time-indexed video segment, K≧2. At step 806, the repeat clip instances are identified based on correlation of the video segments.

Example embodiments can provide a real-time short video clip mining apparatus/or method to automatically discovery short repeat video segments from large video collections robustly and efficiently.

Example embodiments can provide a real-time short video clip mining apparatus/or method where TV commercials, program logos, sports video replay logo, news lead-in, lead-outs and many other diverse short repeat video clips can be mined under the proposed apparatus and method.

Example embodiments utilise locality-sensitive hashing is used to calculate auto-correlation of video samples so that short video clip mining can be efficiently performed over large video collections, for instance, hundred hours long video content, in a few seconds.

Example embodiments can be used for various short video clip mining, including TV commercials, program lead-in and lead-out, sports replay logo, ranging from less than one second to several minutes long.

Example embodiments do not use black frames for TV commercials detection, therefore it can be used worldwide in contrast to most of the existed methods for TV commercials detection.

Example embodiments utilise locality sensitive hashing of video clip features to reduce computational cost drastically, up to 100 times speed up can be achieved. So the proposed method can be used to mine large video collection in real-time.

Example embodiment utilise non-uniform extracted key frames and their color fingerprint, and segment lengths for repeat short video clip mining to achieve both robust and efficient operation in real-time.

Applications of example embodiments include, but are not limited to, set top box applications, network server based applications, PVR, DVDR, home media center, video content annotation, MPEG7 metadata creation and personlized media.

Example embodiments can be applied to video structure analysis. For example, many TV stations are willing to insert short video clips before or after a program section, such as financial or sport news, in the fixed broadcasting programs such as everyday news programs, to indicate topic changes. These program sections are usually consistently arranged in the same way for different days, at least for a period of time. Therefore, the syntactic short video clips associated with those program sections will also follow the same pattern. As a result, if one can discover the distribution of the short video clips, the corresponding video structure can be reconstructed. Some of the short video clips may be repeated several times in one day's program while others may be repeated on different days. Therefore, one may collect several days' programs over a fixed time period to discover such repeat short clips, and conduct a video structure analysis as follows.

After identifying and labelling repeat short video clips from the collected video data using the example embodiment described herein, the repeat instances can be plotted on a temporal axis to visualise the locations of the instances. Those locations can be exploited for video structure analysis if there exist stable temporal structures formed by one or more of the short video clip instances, which may be referred to as marker clips. These marker clips divide the video data or stream into sections, and program types, characteristics, or both of the sections may further be derived.

Next, redundant and trivial marker instances are removed, choosing the remaining or significant instances as segmentation nodes to describe the video structure. A directed graph may be used to fully describe the structure. Attributes of the nodes may be referred to as clip labels, and the nodes are temporally ordered in the directed graph. If two instances are neighbouring, there is a directed edge between them, and edge attributes including time distance between the two instances as well as program section attributes are associated with the edge. Because distances between marker clip instances in different day programs may have some variation, the average distance between the instances may be used as the edge value.

An inferred structure G (of the directed graph) can then be applied to new recorded video programs to automatically extract and index different topic sections. Again, instances of marker short clips are first searched in the new recorded video program, and a directed graph G1 is used to model the temporal order and distances between marker short clips instances. Next, the nodes of G1 are to be registered to the nodes of G. Constraints of the registrations may be as follows:
1) One node in G1 can be registered to only 1 node in G or null node.
2) Any two nodes in G1 cannot be registered to the same node G.
3) The temporal order of nodes cannot be changed.

The registration algorithm may be as follows:
1) Get a string representation of all the ordered nodes in G and G1, denoted by S and S1, than find the longest common sub-sequences with all possible alignments between the two strings S and S1.
2) For each possible alignment, compute the difference of time distance between align nodes. The alignment that achieves the smallest distance difference is chosen as optimal registration.
3) After registration is finished, video stream segmentation is also automatically accomplished in such an example embodiment.

It will be appreciated by a person skilled in the art that numerous variations and/or modifications may be made to the present invention as shown in the specific embodiments without departing from the spirit or scope of the invention as broadly describe. The present embodiments are, therefore, to be considered in all respects to be illustrative and not restrictive.

1. A method of identifying repeat clip instances in video data, the method comprising:
partitioning the video data into ordered video units utilising content-based keyframe sampling, wherein each video unit includes a sequence interval between two consecutive keyframes;
grouping at least two consecutive video units into one time-indexed video segment; and
identifying the repeat clip instances based on correlation of the video segments.

2. The method as claimed in claim 1, wherein a fingerprint is created for each video unit, the fingerprint comprising a content-based feature vector.

3. The method as claimed in claim 2, wherein the content-based feature vector is based on one or more of a group consisting of a color content, an image histogram, a segment length and motion activities of the video unit.

4. The method as claimed in claim 1, wherein a correlation matrix of video segments from one input video alone is derived based on an auto-correlation of the fingerprints and on temporal features of the time-indexed video segments, and the repeat clip instances are identified from the correlation matrix.

5. The method as claimed in claim 1, wherein a correlation matrix of video segments from two different input videos is derived based on cross-correlation of the fingerprints and on temporal features of the time-indexed video segments, and the repeat clip instances are identified from the correlation matrix.

6. The method as claimed in claim 4, wherein a similarity between video segments is defined as a binary value, with one pair of identical video segments correspond to element “1” in the correlation matrix, and the repeat clips are identified from the observation of those identical video segments.

7. The method as claimed in claim 6, wherein only the time indices of elements “1” are recorded in an array while the entire correlation matrix is not recorded.

8. The method as claimed in claim 6, further comprising connecting line segments in the correlation matrix, each line segment comprising diagonally adjacent matrix elements of the same value “1”, for identifying the repeat clip instances.

9. The method as claimed in claim 8, wherein the line segments connecting proceeds in a hierarchical way, wherein most reliable line segments with a length≧2 are first connected, followed by connecting less reliable line segments with a length=1 to expand a line segment boundary.

10. The method as claimed in claim 8, wherein the connecting of the line segments is based on a temporal relation of the associated video sequences.

11. The method as claimed in claim 4, further comprising performing a locality-sensitive hashing to identify fingerprints that are within a pre-determined distance from each other, and calculating elements of the correlation matrix only for said identified fingerprints.

12. The method as claimed in claim 11, wherein the fingerprints are transformed into a bit string, and the hashing is applied to the bit strings corresponding to the respective fingerprints.

13. The method as claimed in claim 4, further comprising conducting a frame-by-frame frame feature comparison of the identified repeat clip instances to verify said repeat clip instances if a comparison measure is above a pre-determined threshold.

14. The method as claimed in claim 13, further comprising conducting a frame-by-frame boundary expansion for verified repeat clip instances.

15. The method as claimed in claim 4, further comprising labeling repeat clip instances as belonging to same or different groups of matched repeat clip instances based on a temporal relationship between the associated video sequences.

16. The method as claimed in claim 1, wherein the keyframes are identified based on a content histogam of each frame of the video stream.

17. The method as claimed in claim 16, wherein the content histogram comprises a color histogram or a motion histogram.

18. The method as claimed in claim 1, wherein the video data comprises one or two video streams.

19. The method as claimed in claim 1, wherein the video data comprises one or two stored video collection data.

20. The method as claimed in claim 1, wherein the video data comprises one stored video collection data and one video stream.

21. The method as claimed in claim 1, wherein the method is performed on-line in real time.

22. The method as claimed in claim 1, wherein the method is performed off-line.

23. A system for identifying repeat clip instances in video data, the system comprising:
a partitioning unit for partitioning the video data into ordered video units utilising content-based keyframe sampling, wherein each video unit includes asequence interval between two consecutive keyframes;
a processor for grouping at least two consecutive video units into one time-indexed video segment and for identifying the repeat clip instances based on correlation of the video segments.

24. A data storage medium having stored thereon computer code means for instructing a computer to execute a method of identifying repeat clip instances in video data, the method comprising:
partitioning the video data into ordered video units utilising content-based keyframe sampling, wherein each video unit includes a sequence interval between two consecutive keyframes;
grouping at least two consecutive video units into one time-indexed video segment; and
identifying the repeat clip instances based on correlation of the video segments.
